(19) United States
(12) Patent Application Publication
(10) Pub. No.: US 2020/0370831 A1
(43) Pub. Date: Nov. 26, 2020

(54) APPARATUS FOR MAKING A METAL PART

(71) Applicant: GEDIA GEBRÜDER DINGERKUS GMBH, Attendorn (DE)

(72) Inventors: Volker FLESCH, Attendorn (DE); Björn MÜLLER, Attendorn (DE); Patrick MÜLLER, Kirchhundem (DE); Maik WINDERLICH, Drolshagen (DE); Thorsten WISNIA, Attendorn (DE)

(21) Appl. No.: 16/959,310

(22) PCT Filed: Nov. 21, 2018
(86) PCT No.: PCT/DE2018/100967

§ 371 Date: Jun. 30, 2020

(30) Foreign Application Priority Data
Feb. 13, 2018 (DE) 10 2018 103 143.2

(51) Int. Cl. F27B 5/14; F27B 5/18

(52) U.S. Cl. CPC F27B 5/14; F27D 21/0014; F27B 5/18

(57) ABSTRACT

The invention relates to a facility for producing a metal component having at least two regions of different strength properties, said facility consisting of a heating unit (2) comprising heat-producing radiation sources (4) as well as a positioning device for at least one base body (1) consisting of metal, and a protecting device comprising at least one covering part for the contactless protection of a pre-determined surface region of the base body (1), the protecting device being arranged in the heating unit such that it remains therein during a temperature control of the base body (1) before the forming of the base body in a forming tool, the protecting part comprising a plurality of separately manipulatable covering parts (3a, 3b, 3c, 3d, 3e) which are respectively used to protect a predetermined surface region (1a, 1b, 1c, 1d, 1e) of the Base Body (1), and a Manipulator (5) is Provided for Each Covering Part (3a to 3e), by means of which the covering part (3a to 3e) can be moved, independently from the other covering parts (3a to 3e) in the heating unit (2), into a covering position in which it covers the pre-determined surface region (1a to 1e), or into an uncovering position in which it uncovers the pre-determined surface region (1a to 1e) for the irradiation of the radiation sources (4).

The invention relates to an apparatus for making a metal part having at least two regions with different strength properties, comprising a heater with heat-generating radiation sources and with a positioner for at least one plate or similar base body made of metal, a shield with at least one cover for contactless shielding of a predetermined region of the plate or the base body, where the shield is designed to remain in the heater while the plate or the base body is heated and before it is formed in a deforming tool.

Such an apparatus is known from DE 10 2012 016 075.

The term metal part is to be understood as meaning both plates and flat products cut out of plates that form intermediate products for a finished part that will be manufactured from them. A method that is also used in the present invention is described in the prior art. Accordingly, a metallic base body, for example a steel sheet or a piece of one, which can also be coated, is first heated to a suitable temperature, for example, to austenitizing temperature in the case of steel. The coating can be, for example, an aluminum-silicon coating that is alloyed by appropriate heating and thus creates an optimal connection with the base part. The base body or the plate is brought into the heater at this temperature, and is partially shielded by a shield accompanying the workpiece to prevent further heat penetration in subregions thereof, whereas the base body is still subjected to heat in the corresponding heater. In this way, the unshielded region of the base body or the plate continues to be kept at the austenitizing temperature or the corresponding temperature, while the shielded region can cool down in a controlled manner, for example below the austenitizing temperature but above the martensite starting temperature. In this part region preferably an average cooling rate prevails that is below that critical for martensite formation, such that the structure of this region after the subsequent forming, assuming the object is steel, mainly consists of ferrite and pearlite, regardless of the subsequent cooling rate during the forming process. The shielded regions cool down more slowly than a passive cooling in air. After the shielding has been removed, the base body or the plate that has been accordingly processed and that then has a graded temperature profile obtained by the shielding undergoes a shaping process using a tool, in particular, hot shaping with press hardening at the same time. At least in the previously unshielded region of the base body or the plate, a cooling rate above the cooling rate critical for martensite formation (in the case of steel) is maintained. This means that the base body cools down so quickly that a predominantly martensite structure is created in the previously unshielded region. During the forming process, it is not necessary to establish different cooling rates for the different regions. In particular, the two regions of the base body can be cooled down at a cooling rate greater than the critical cooling rate for the formation of martensite, since, due to the partial cooling of the shielded region that has already taken place, martensite conversion can only occur in the region that was not previously shielded.

A corresponding shield is described in the prior art to carry out this method that is designed and used to cover a corresponding region of the metal part.

In principle, such an apparatus is well suited to produce custom products. However, the conventional technology only allows creating parts that have regions with two different strengths. If, in the final state, parts need to have more than two different strengths, this is conventionally only possible by prefabricating several parts that are then joined to form a complete part, for example by welding.

Proceeding from this prior art, the object of the invention is to provide an apparatus in the described type with which it is possible to create complex parts with different strengths that can be formed in one piece.

To attain this object, the invention proposes that the shield comprises a plurality of individually manipulable covers, each intended for shielding a predetermined surface region of the plate or the base body, and that a respective manipulator is provided for moving each cover in the heater independently of the other covers into a covering position in which it covers the respective surface region, or into an exposing position in which it exposes the respective surface region to the radiation from the radiation sources.

According to the invention, several separately manipulable covers are provided, each of which is intended to shield a predetermined surface region of the plate or the base body. For example, five such separately manipulable covers can be provided. Each cover has a respective such manipulator that can move the respective cover in the heater independently of the other covers into a covering position in which it covers the predetermined surface region, or into an exposing position in which it exposes the predetermined surface region for the radiation from the radiation sources. This configuration makes it possible to create a part or a base body that has several, for example five, different strengths in a part that one single piece. The different strengths can, for example, improve the crash properties required in automobile construction and meet special requirements in this regard, even while only requiring a single, one-piece part. As is known in the prior art, this part undergoes a hot-shaping process after the corresponding heating or cooling, and a correspondingly rapid cooling can take place simultaneously or with a time delay for press hardening.

It is particularly preferred that the manipulators are actuated by an electronic controller installed on the apparatus or integrated with it to set the different operating positions.

The various covers can be moved, for example by mechanical drives, into the covering positions or into the exposing positions, and the manipulators used for this purpose are actuated by an electronic controller. This makes it possible to store a corresponding programming in the controller in order to set the manipulators into the desired operating positions in a suitable manner at different times.

It is also preferably provided that the manipulators are combined with a time controller so that they move the covers to the different operating positions as a function of time.

As a result, the manipulators can be combined with a time controller that can be adjusted by the operator so it is possible to position the covers as a function of time, which in turn leads in a simple manner to a part that acquires a plurality of different strengths corresponding to the arrangement of the plurality of covers.

It is also preferably provided that each cover consists of a pair of cover templates lying opposite each other that cover a subregion of the plate or of the base body in the covering position, namely on the underside, on the top, and optionally on the edge.

Such an arrangement enables a largely symmetrical arrangement of the pairs of individual cover templates forming a cover that can then be accommodated in a simple manner in the heater. The heater can be a feed-through oven or a stationary oven.

In the covering position, the cover templates of each pair move toward each other in such a manner that they form a continuous cover whereas in the exposing position the cover templates are moved in the opposite direction, such that they are next to the corresponding workpiece (plate or base body) on each respective side.

For this purpose, it is particularly preferably provided that the manipulators move each pair of cover templates of the cover into the different operating positions at the same time.

It can also be provided that the covers of the apparatus that are arranged next to each other are arranged to form a movement gap.

It is preferably provided that the covers arranged next to each other are spaced apart by a gap of 25 to 100 mm.

Such a configuration enables transition regions of a corresponding size, for example between 25 and 100 mm, such that the regions of different strengths do not directly adjoin each other, but rather via a transition region. This is often desirable for properties of the finished part that are desired subsequently.

It can also be provided that the side edges of the covers or at least some covers have a greater material thickness than in the remaining region of the covers and/or have a greater vertical distance from the plate or the base body in the covering positions.

Such a configuration enables influencing the transition region by varying the thickness of the respective cover near its side edge that is adjacent the next element, such that the shielding effect is variable in the direction of the transition zones to be formed. Such variability can also be produced by the corresponding cover having a greater spacing near its edge region from the plate or the base body in the covering position. For example, the cover can have an bent-up edge region. Both measures can also be used at the same time.

In particular, it is preferably provided that a shaping tool is connected to the apparatus or is arranged adjacent it for receiving and forming the plate or the base body after the heating, and optionally hardening it.

The invention further provides a metal part in the form of a plate or a one-piece base body that is characterized in that the metal part has more than two surface regions of different strengths over its length and/or width.

Such a one-piece metal part is particularly advantageous in automotive engineering because it can be adapted in a suitable manner to desired crash properties, and the transition regions between the heat-treated regions can also be implemented differently. In particular, such a metal part comprises a plurality of regions of different strengths, preferably three to five such regions.

An embodiment of the invention is shown in the drawing and described in more detail below, where:

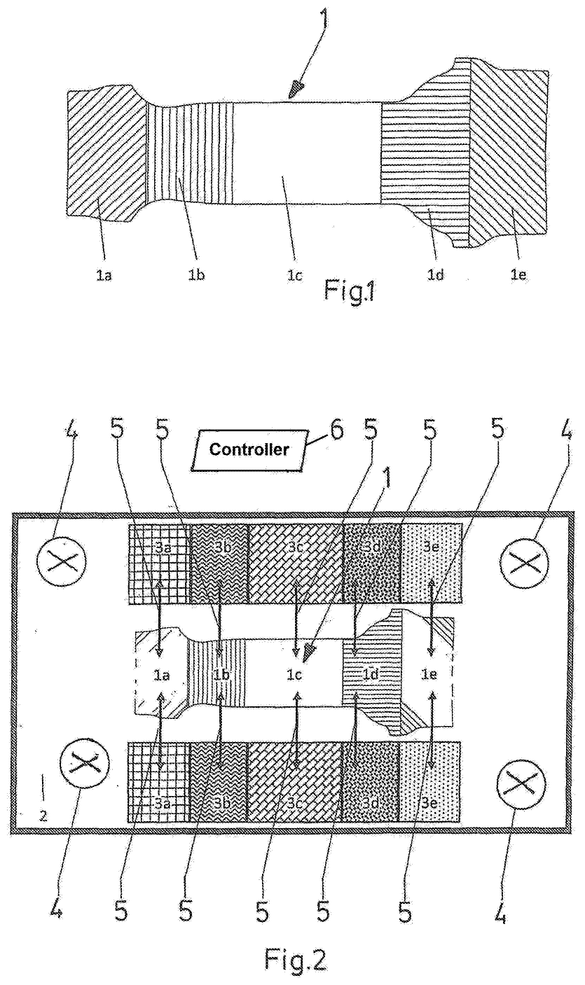

FIG. 1 schematically shows a flat part having five regions of different strength;

FIG. 2 is a schematic representation of an apparatus according to the invention.

FIG. 1 shows a metal part according to the invention in the form of a one-piece base body 1. This metal part has a plurality of regions 1a, 1b, 1c, 1d, 1e of different strengths over its length (seen in the direction from left to right in the drawing). The different strengths are indicated in the drawing by different hatchings. Although the metal part in the form of the base body 1 is shown as a flat element, this special feature is of course substantially achieved and realized even when the base body 1 is hot formed and assumes a corresponding three-dimensional shape.

FIG. 2 shows an apparatus with which such a metal part can be prefabricated before it is then formed and hardened in a deforming tool.

The apparatus is used to produce a corresponding metal part in the form of a plate or a base body 1 made of metal. The apparatus consists of a heater 2 with heat-generating radiation sources 4. The heater 2 can be implemented as a feed oven or as a closed oven.

Positioners for the base body 1, on which the base body 1 can be placed, are provided in the heater 2, but are nevertheless accessible on all sides for radiant heat. These can be, for example, pin-like supports or the like. Furthermore, a series of shields with covers 3a, 3b, 3c, 3d, 3e is provided. These are provided for contactless shielding of a predetermined surface region of the base body 1. These shields are designed to stay in the heater 2 during heating of the base body 1 in the heater, prior to the base body being formed in a subsequent forming process and deforming tool.

According to the invention, the shield consists of a plurality of separately manipulable covers 3a, 3b, 3c, 3d, 3e, each of which is intended for shielding a respective surface region 1a, 1b, 1c, 1d, 1e of the base body 1. Each cover 3a to 3e has a respective manipulator 5 shown here in the drawing by arrows that at the same time illustrate the movement of the respective cover 3a to 3e. This configuration makes it possible to move each of the covers 3a to 3e independently of the other covers in the heater 2 into a covering position, in which it covers the predetermined surface region 1a to 1e, or into an exposing position as shown in the drawing, in which it exposes the predetermined surface region to the rays of the radiation sources 4.

The manipulators 5 can be actuated by an electronic controller 6 that hard-wired or wirelessly connected to the manipulators 5. The controller 6 is mounted on apparatus parts, for example on a control panel of the heater 2.

In particular, the manipulators 5 can be combined with a time controller via the controller 6 such that they can move the covers 3a to 3e into the different operating positions as a function of time.

Each cover 3a to 3e consists of a pair of cover templates positioned opposite each other, as can be clearly seen in FIG. 2, each of which can cover a subregion of the base body 1 in the covering position, specifically on the underside, top, and optionally on the edge. In the drawing, the cover templates of each cover 3a to 3e are shown in the exposing position. In the covering position, the covering templates are moved toward each other corresponding to the direction indicated by the arrows, such that they completely cover the corresponding region of the base body 1. The manipulators 5 preferably move each pair of cover templates of each cover 3a to 3e simultaneously into the different operating positions.

The covers 3a to 3e of the apparatus are next to each other and preferably arranged to form at least one movement gap, and are preferably arranged to form a spacing gap from each other of 25 mm to 100 mm. In this way, corresponding transition zones can be formed between the individual surface regions 1a to 1e.

The apparatus is completed by a deforming tool that is not shown in the drawing. After being heated as intended, the base body is fed to the deforming tool, shaped in it, and optionally press-hardened at the same time.

With the apparatus according to the invention, it is possible in a simple manner to make parts having several different strengths in a one-piece part, this being achieved by correspondingly controlling the covers that are moved in the heat treatment system 2 at different times (in the direction indicated by the arrows) to set the different operating positions. As a result, each controlled region of the base body 1 can reach a different heat treatment temperature and subsequently a different heat-treatment temperature in the further course of the method, which leads to different strengths in the one-piece finished part.

The invention is not limited to the illustrated embodiment, but rather is variable in many ways within the scope of the disclosure.

All new individual and combination features disclosed in the description and/or drawing are regarded as essential to the invention.

1. An apparatus for making a metal part having a a plurality of different strength properties, the apparatus comprising:
a heater having heat-generating radiation sources,
a positioner for a heat-treatable workpiece made of metal,
a shield having a plurality of covers for contactless shielding of a respective surface regions d of the workpiece, and constructed to remain in the heater during heating of the workpiece before same is shaped in a deforming tool, and
a respective manipulator for moving each cover in the heater independently of the other covers into a covering position in which it covers the respective surface region or into an exposing position in which it exposes the respective surface region to rays of the radiation sources.

2. The apparatus according to claim 1, further comprising:
an electronic controlling operating the manipulators and installed on the apparatus or integrated in it for setting the different operating positions.

3. The apparatus according to claim 1, further comprising:
a time controller for operating the manipulators to move the covers into different operating positions as a function of time.

4. The apparatus according to claim 1, wherein each cover consists of a pair of opposing cover templates that together cover the respective region of the workpiece in the covering position.

5. The apparatus according to claim 4, wherein the manipulators move each pair of cover templates of the cover simultaneously into the different operating positions.

6. The apparatus according to claim 1, wherein the covers are spaced from one another and form movement gaps.

7. The apparatus according to claim 6, wherein each of the covers is spaced from adjacent covers by a gap of 25 to 100 mm.

8. The apparatus according to claim 1, wherein side edges of at least some of the covers have a greater material thickness than the rest of the respective covers or have a greater vertical spacing from the workpiece in the covering position.

9. The apparatus according claim 1, wherein the deforming tool is connected to the apparatus or is arranged adjacent it, and receives and shapes the workpiece after heating.

10. A metal part in the form of a plate or a one-piece base body, wherein the metal part has more than two surface regions of mutually different strengths over its length and/or width extension.
